(19) United States
(12) Patent Application Publication
(10) Pub. No.: US 2006/0230339 A1
(43) Pub. Date: Oct. 12, 2006

(54) System and method for high performance pre-parsed markup language

(76) Inventors: Phani Gopal V. Achanta, Austin, TX (US); Scott Thomas Jones, Austin, TX (US)

Correspondence Address: IBM CORPORATION- AUSTIN (JVL);C/O VAN LEEUWEN & VAN LEEUWEN, PO BOX 90609, AUSTIN, TX, 78709-0609, US

(21) Appl. No.: 11/101,620

(22) Filed: Apr. 7, 2005

(51) Int. Cl. G06F 17/24

(52) U.S. Cl. 715/513; 715/523

(57) ABSTRACT

A system and method for high performance pre-parsed markup language is presented. A file converter performs translation between a binary data file and a markup language file. When translating a binary data file, the file converter translates binary data header tags and binary data sizes to markup language elements and markup language data sizes, respectively, and stores them in a markup language header. The file converter then translates the binary data file's records to markup language records. When a user is finished modifying the markup language file, the file converter translates the markup language file back to a binary data file by translating the markup language header tags and markup language data sizes to binary data header tags and binary data sizes, respectively, and stores them in a binary data header. The file converter then translates the markup language file's records to binary data records.

### BACKGROUND OF THE INVENTION

1. Technical Field

The present invention relates in general to a system and method for high performance pre-parsed markup language. More particularly, the present invention relates to a system and method for bi-directional translation between a binary data file and a markup language file.

2. Description of the Related Art

Common data structures are a problem when projects evolve as a set of independent programs and each of the independent programs use only a subset of the common data structure. This problem worsens as each individual program enhances or changes portions of the common data structure that it uses. A challenge found is that constant updates to common data structures are problematic, which are only partially alleviated by adding version numbers to the data.

Common data structures are typically stored in a binary data file for optimal program performance. However, a binary data file is not user-friendly and is difficult to modify. A markup language, such as Extensible Markup Language (XML), is often used to provide a more flexible data transmission medium, which allows the common data structures to be enhanced or changed by the addition of tags. These new tags allow new data to be added to the common data structures without impacting existing code in other programs on a project. However, a markup language file is not optimized for program performance because the markup language file's data has to be parsed in order for a program to access the data. A challenge found is that if there are frequent transitions from one program of a project to another, the process of constantly creating and parsing markup language data may severely impact the overall project performance.

What is needed, therefore, is a system and method for translating a structured binary data file to a markup language file and visa versa in order to benefit from the performance advantage of a structured binary data file, while benefiting from the user friendliness of a markup language file.

### SUMMARY

It has been discovered that the aforementioned challenges are resolved using a system and method for translating between a binary data file and a markup language file. A user uses a binary data file and a corresponding markup language file for two distinct purposes. The user uses a binary data file during program execution for optimal performance and uses a markup language file for modifying data due to its user-friendliness.

During product development, a user sends requests to a client to translate between a binary data file and a markup language file. When the user wishes to convert a binary data file to a markup language file, the user sends a data file conversion request to the client. The client's file converter retrieves a binary data header from the binary data file and identifies binary data header tags and their corresponding binary data sizes that are included in the binary data header. A binary data header tag may be a container tag or a stand-alone tag. A binary data container tag encompasses other binary data header tags and does not have associated data. Meaning, a binary data container tag's corresponding binary data size is zero. A stand-alone tag has associated data and may represent a string.

Binary data sizes represent the number of bytes that are allocated for storing the binary data header tag's values (e.g., binary data values). For example, a binary data header tag may be “timeleft” and its corresponding binary data size may be “4” bytes long. In this example, a binary data value corresponding to “timeleft” is four bytes.

The file converter builds a table in memory that includes the identified binary data header tags and their corresponding binary data sizes. Once the table is built, the file converter generates a markup language header using the stored binary data header tags and the binary data sizes, and stores the markup language header in the markup language file. During the markup language header generation process, the file converter converts the binary data header tags to markup language elements and converts the binary data sizes to markup language data sizes.

Once the markup language header is generated, the file converter identifies binary data records included in the binary data file along with corresponding binary data values. The file converter uses the information stored in the table to translate the binary data records to markup language records, which are stored in the markup language file. During the translation process, the file converter uses the binary data header tags to generate markup language tags and coverts the binary data values to markup language data values. The user is now able to access and modify the markup language file.

When the user wishes to convert the modified markup language file to a modified binary data file for program execution, the user sends a markup language file conversion request to the client. In turn, the client's file converter accesses the markup language header and retrieves markup language elements and their corresponding markup language data sizes. A markup language element may be a container element or a stand-alone element. A markup language container element is an element that “contains” other elements and does not have associated data. A stand-alone element has associated data, may include a string, and may be encompassed by a container element.

When converting a markup language file to a binary data file, the file converter uses an offset to track the location for writing binary data values to a binary data record. The offset is incremented for each markup language element by the amount of its corresponding markup language data size.

The file converter stores the markup language elements, their corresponding markup language data sizes, and their corresponding offsets in a table, and generates a binary data header using the markup language elements and their corresponding markup language data sizes. During the binary data header generation process, the file converter converts the markup language elements to binary data header tags and converts the markup language data sizes to binary data sizes.

Once the binary data header is generated, the file converter identifies markup language records that are included in the markup language file, and uses the information in the table to translate the markup language records to binary data records, which are stored in the binary data file. When the file converter identifies a markup language data value as a string, the file converter stores the corresponding string in a string file and stores a string counter number in the binary data records. Once the modified binary data file is generated, the user instructs the client to execute a program that accesses the binary data file.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings.

FIG. 1 is a diagram showing a file converter translating a binary data file to a markup language file and visa versa;

FIG. 2A is a high-level flowchart showing steps taken in converting a binary data file to a markup language file;

FIG. 2B is a high-level flowchart showing steps taken in converting a markup language file to a binary data file;

FIG. 3 is a flowchart showing steps taken in converting a binary data header to a markup language header;

FIG. 4 is a flowchart showing steps taken in converting binary data records to markup language records;

FIG. 5 is a flowchart showing steps taken in converting a markup language header to a binary data header;

FIG. 6 is a flowchart showing steps taken in converting markup language records to binary data records;

FIG. 7 is an example of a binary data header;

FIG. 8A is an example of binary data records;

FIG. 8B is an example of a binary string file;

FIG. 9 is an example of a markup language header;

FIG. 10 is an example of markup language records; and

FIG. 11 is a block diagram of a computing device capable of implementing the present invention.

### DETAILED DESCRIPTION

The following is intended to provide a detailed description of an example of the invention and should not be taken to be limiting of the invention itself. Rather, any number of variations may fall within the scope of the invention, which is defined in the claims following the description.

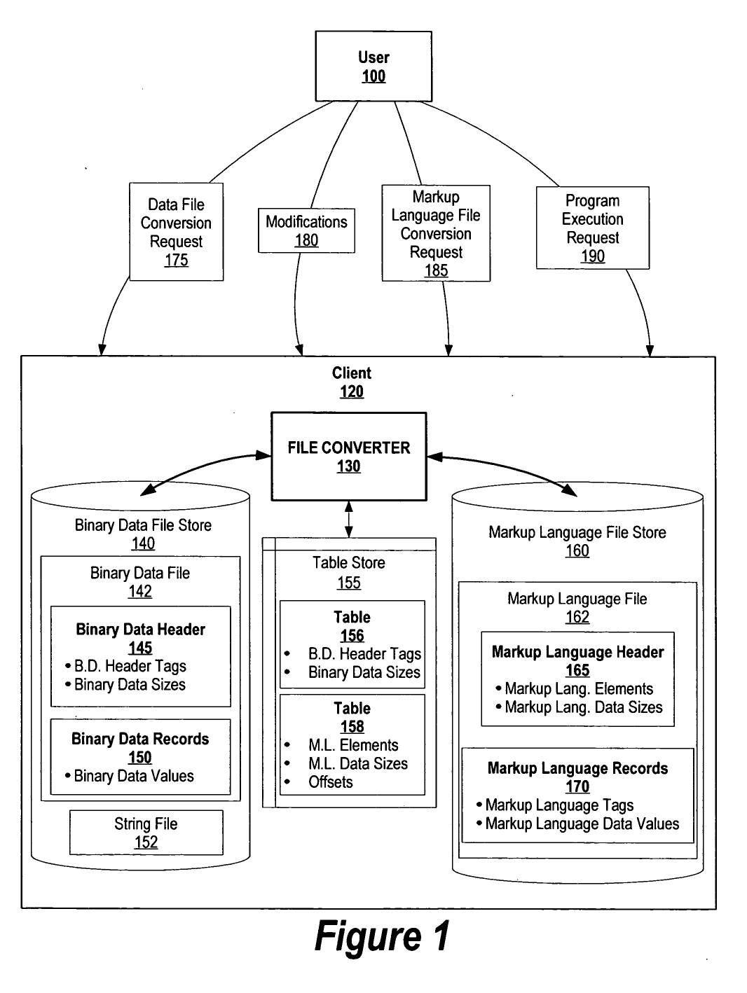

FIG. 1 is a diagram showing a file converter translating a binary data file to a markup language file and visa versa. User 100 uses a binary data file and a corresponding markup language file for two distinct purposes. User 100 uses a binary data file during program execution for optimal performance and uses a markup language file for modifying data due to its user-friendliness. The examples described herein correspond to a particular markup language type, which is Extensible Markup Language (XML). As one skilled in the art can appreciate, the invention is applicable to other Standard Generalized Markup Languages (SGMLs) that are data description languages.

During product development, user 100 sends requests to client 120 to translate between a binary data file and a markup language file. When user 100 wishes to convert a binary data file to a markup language file, user 100 sends data file conversion request 175 to client 120. Client 120 includes file converter 130, which performs data file conversion steps.

Binary data file store 140 includes binary data file 142, which is the file that user 100 wishes to convert. Binary data file 142 includes binary data header 145 and binary data records 150. In addition, binary data file store 140 includes string file 152 that stores strings corresponding to binary data records 150. Binary data store 140 may be stored on a nonvolatile storage area, such as a computer hard drive.

File converter 130 retrieves binary data header 145, and identifies binary data header tags and their corresponding binary data sizes that are included in binary data header 145. A binary data header tag may be a container tag or a stand-alone tag. A binary data container tag does not have associated data and encompasses other binary data header tags. Meaning, a binary data container tag's corresponding binary data size is zero. On the other hand, a stand-alone tag has associated data, which may include a string. Binary data sizes represent the number of bytes that are allocated for storing binary data header tag's values (e.g., binary data values). For example, a binary data header tag may be “timeleft” and the corresponding binary data size may be “4” bytes long. In this example, a binary data value corresponding to “timeleft” is four bytes.

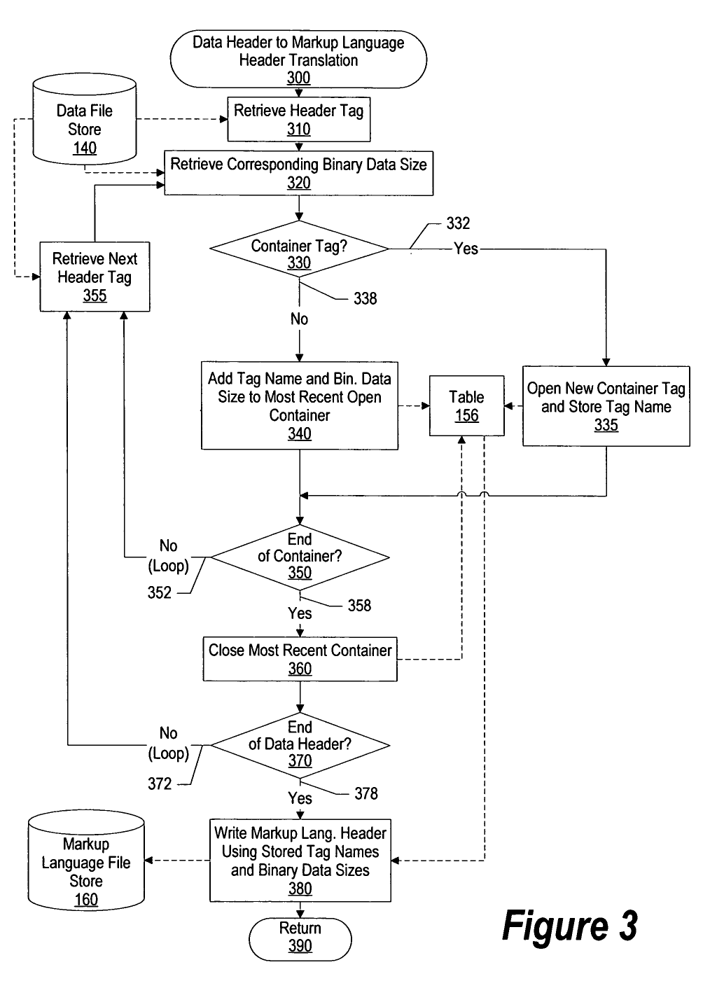

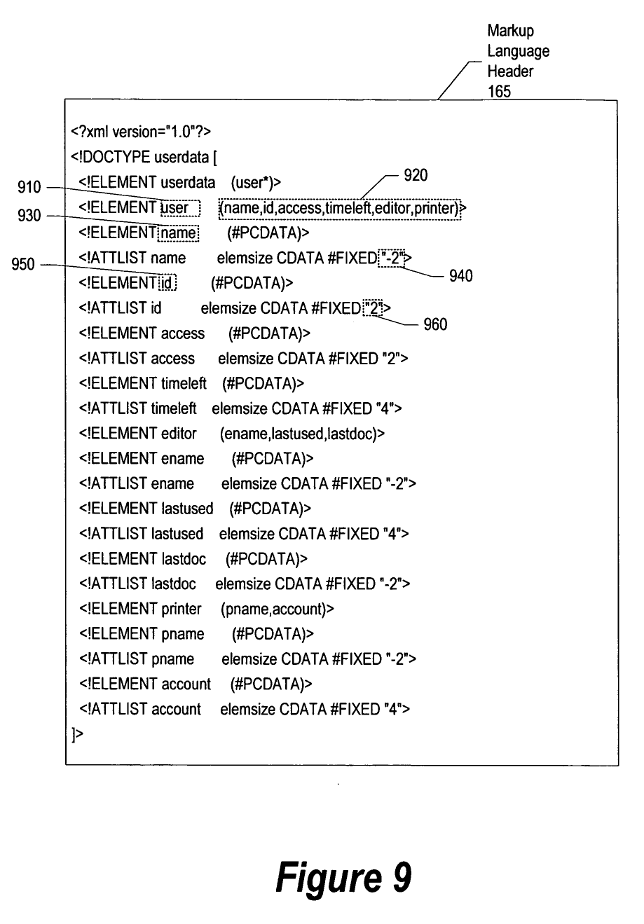

File converter 130 builds table 156 in table store 155 that includes the identified binary data header tags and their corresponding binary data sizes. Once table 156 is built, file converter 130 generates markup language header 165 using the stored binary data header tags and the binary data sizes, and stores markup language header 165 in markup language file 162. During the markup language header generation process, file converter 130 converts the binary data header tags to markup language elements and converts the binary data sizes to markup language data sizes (see FIGS. 3, 9, and corresponding text for further details regarding markup language header generation and properties). Markup language file 162 is located in markup language file store 160, which may be stored on a nonvolatile storage area, such as a computer hard drive. Table store 155 may be stored on a volatile storage area, preferably in computer memory.

Once markup language header 165 is generated, file converter 130 identifies binary data records and their corresponding binary data values that are included in binary data records 150. File converter 130 uses the information stored in table 156 to translate the binary data records to markup language records 170, which are stored in markup language file 162.

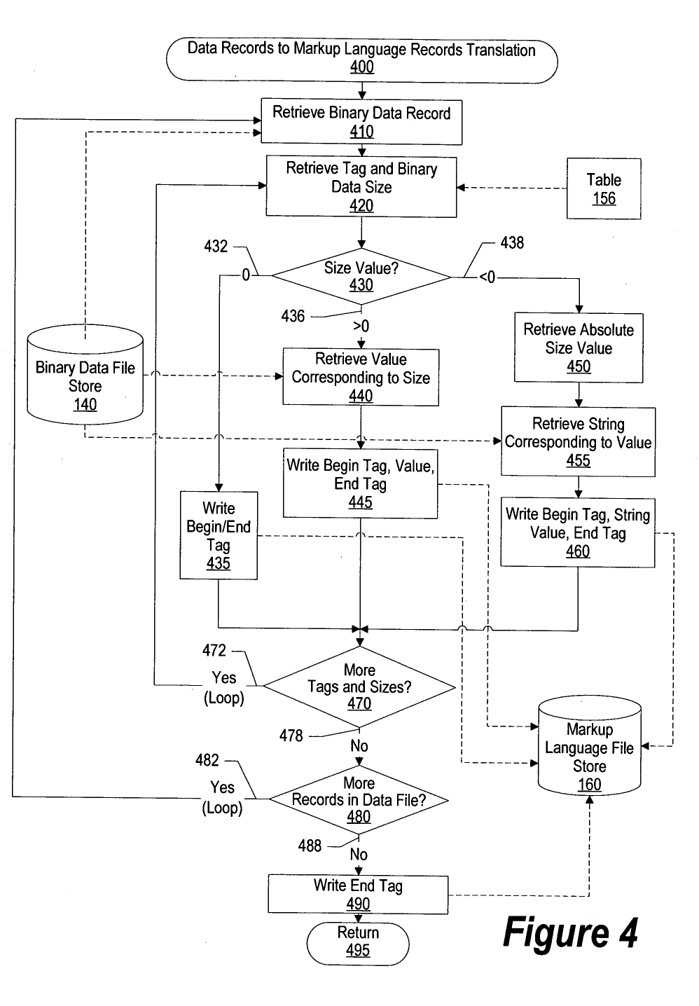

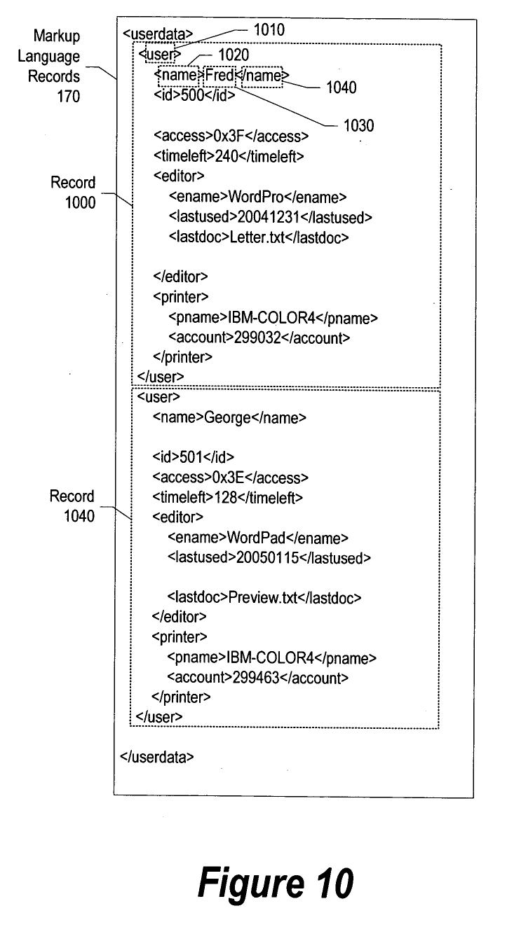

During the translation process, file converter 130 uses the binary data header tags to generate markup language tags and coverts the binary data values to markup language data values (see FIGS. 4, 10, and corresponding text for further details regarding markup language record generation and properties). User 100 is now able to access markup language file 162 and provide modifications 180 to client 120, which modifies markup language file 162.

When user 100 wishes to convert markup language file 162 back to a binary data file for program execution, user 100 sends markup language file conversion request 185 to client 120. In turn, file converter 130 accesses markup language header 165 and retrieves markup language elements and their corresponding markup language data sizes. A markup language element may be a container element or a stand-alone element. A markup language container element is an element that “contains” other elements and does not have associated data. A stand-alone element has associated data, may include a string, and may be encompassed by a container element.

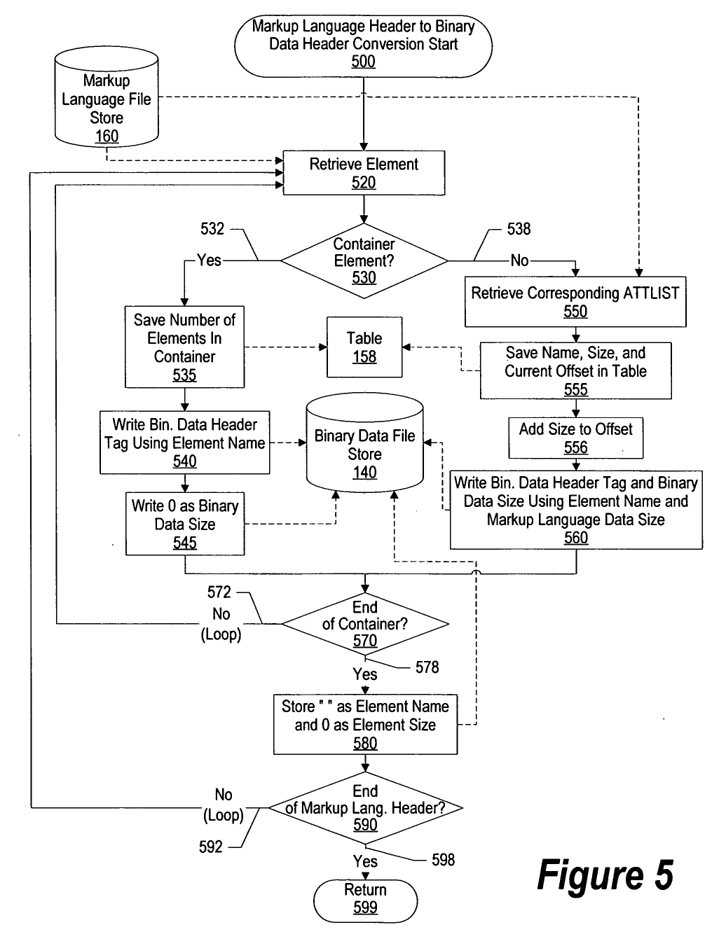

When converting a markup language file to a binary data file, file converter 130 uses an offset to track the location for writing binary data values to a binary data record, which is incremented for each markup language element by the amount of its corresponding markup language data sizes (see FIGS. 5, 6, 8A, and corresponding text for further details regarding offsets).

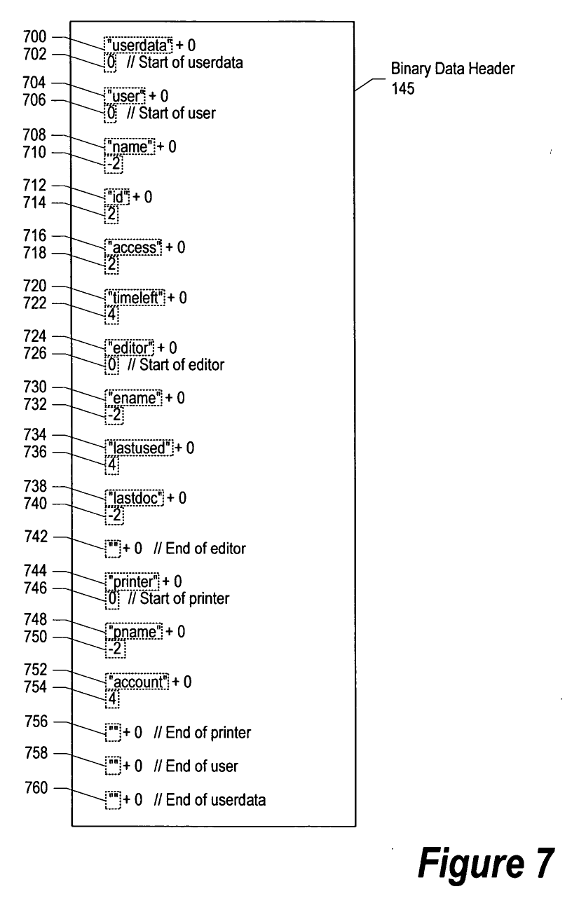

File converter 130 stores the markup language elements, their corresponding markup language data sizes, and their corresponding offsets in table 158 located in table store 155, and also generates binary data header 145 using the markup language elements and their corresponding markup language data sizes. During the binary data header generation, file converter 130 converts the markup language elements to binary data header tags and converts the markup language data sizes to binary data sizes (see FIGS. 5, 7 and corresponding text for further details regarding binary data header generation and properties).

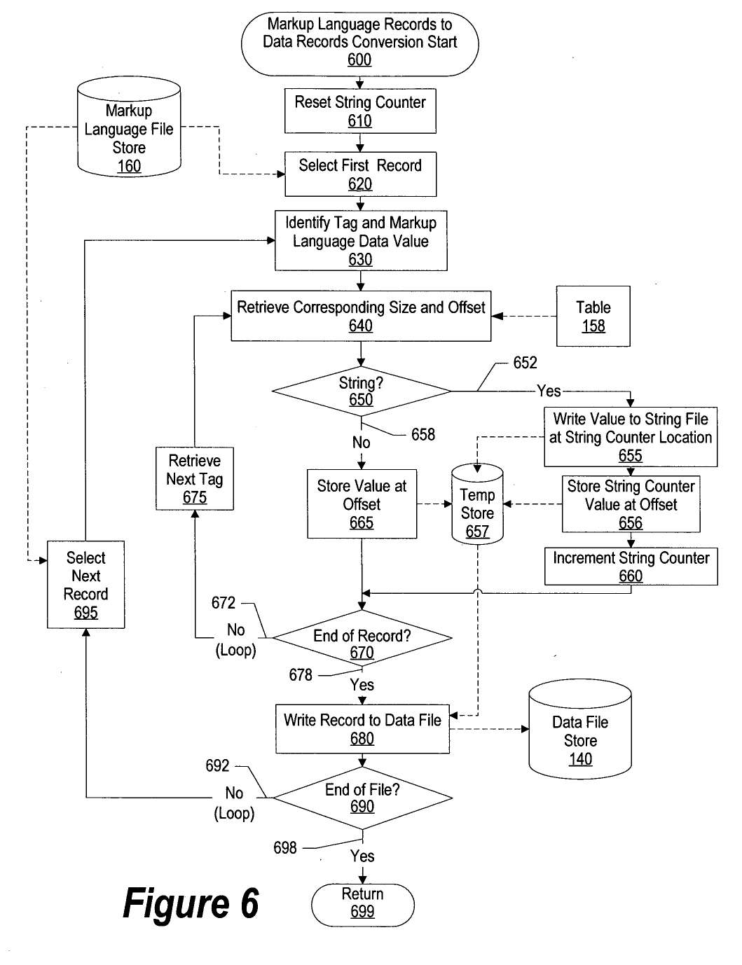

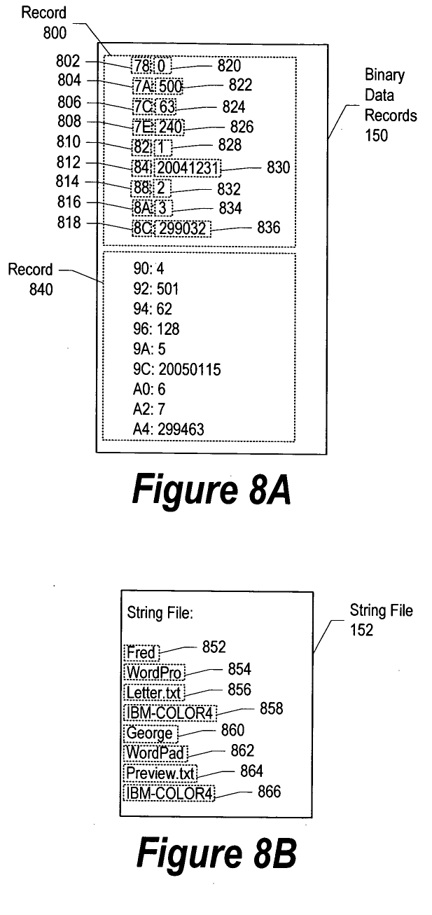

Once binary data header 145 is generated, file converter 130 identifies markup language records that are included in markup language records 170, and uses the information in table 158 to translate the markup language records to binary data records 150, which are stored in binary data file 142. When file converter 130 identifies a markup language data value as a string, file converter 130 stores the corresponding string in string file 152 and stores a string counter number in binary data records 150 (see FIGS. 6, 8A, and corresponding text for further details regarding binary data record generation and properties). Once the modified binary data file 142 is generated, user 100 sends program execution request 190 to client 120 to execute a program that accesses binary data file 142.

In one embodiment, user 100 may easily redesign the layout of the binary data included in binary data records 150 by modifying markup language header 165 because file converter 130 lays out the binary data based upon markup language header 165.

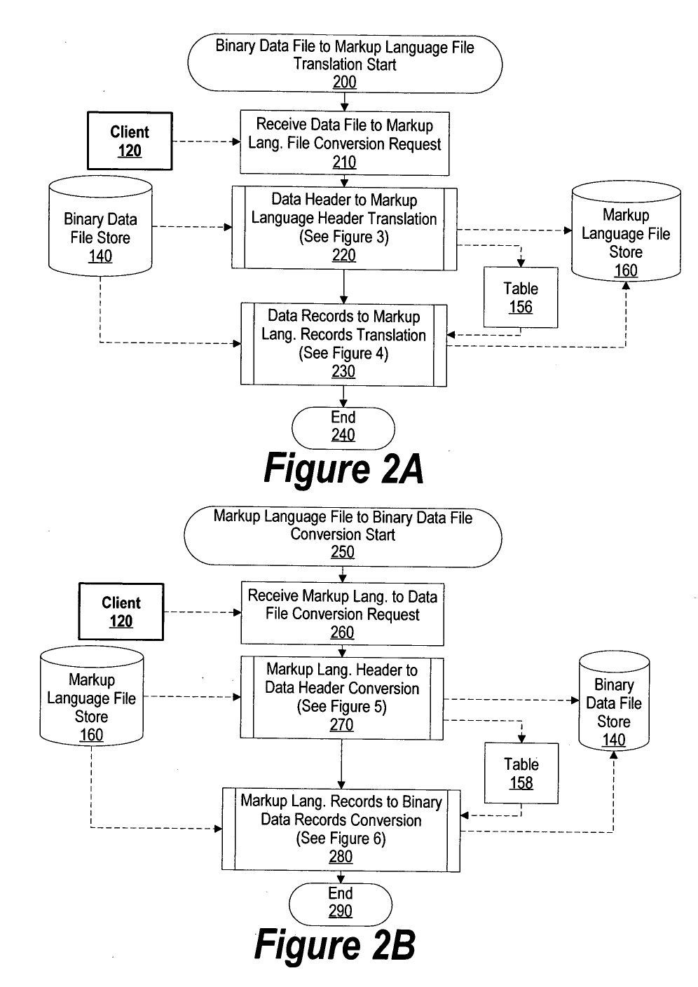

FIG. 2A is a high-level flowchart showing steps taken in converting a binary data file to a markup language file. When a user wishes to modify a binary data file, the user sends a request to a file converter tool that converts the binary data file into a markup language file. In turn, the user is able to easily modify and store the markup language file.

Processing commences at 200, whereupon processing receives a request from client 120 to translate a binary data file to a markup language file (step 210). Processing retrieves the binary data file from binary data store 140 and translates the binary data file's header to a markup language header, which is stored in markup language file store 160 (pre-defined process block 220, see FIG. 3 and corresponding text for further details). During the translation process, processing builds table 156 that includes binary data header tags and binary data sizes that are used to generate the markup language header. Client 120, binary data store 140, markup language file store 160, and table 156 are the same as that shown in FIG. 1.

Processing then identifies binary data records that are included in the binary data file, and uses the information in table 156 to translate the binary data records to markup language records, which are stored in markup language file store 160 (pre-defined process block 230, see FIG. 4 and corresponding text for further details). Processing ends at 240.

The user may modify the markup language file and, in turn, convert the modified markup language file back to a binary data file for use during program execution (see FIG. 2B and corresponding text for further details regarding markup language file to binary data file conversion).

FIG. 2B is a high-level flowchart showing steps taken in converting a markup language file to a binary data file. When a user is finished modifying a markup language file, the user may request to convert the markup language file to a binary data file in order to execute a program using the binary data file.

Processing commences at 250, whereupon processing receives a request from client 120 to convert a markup language file to a binary data file (step 260). Processing retrieves the markup language file from markup language file store 160 and converts the markup language file's header to a binary data header, which is stored in binary data file store 140 (pre-defined process block 270, see FIG. 5 and corresponding text for further details). During the conversion process, processing builds table 158 that includes markup language elements and markup language data sizes that are used to generate the binary data header. Client 120, binary data store 140, markup language file store 160, and table 158 are the same as that shown in FIG. 1.

Processing identifies markup language records that are included in the markup language file, and uses the information included in table 158 to convert the markup language records to binary data records, which are stored in binary data store 140 (pre-defined process block 280, see FIG. 6 and corresponding text for further details). Processing ends at 290.

FIG. 3 is a flowchart showing steps taken in converting a binary data header to a markup language header. Processing received a request to convert a binary data file to a markup language file. As such, processing converts a binary data header that is included in the binary data file to a markup language header. The binary data file is located in data file store 140, which is the same as that shown in FIG. 1.

Processing commences at 300, whereupon processing retrieves a binary data header tag from the binary data header at step 310. At step 320, processing retrieves a binary data size that corresponds to the number of bytes that are allocated for the value of the binary data header tag. For example, a binary data header tag may be “timeleft” and its corresponding binary data size may be “4” bytes long.

Some binary data header tags may correspond to a binary data container tag. A binary data container tag is a tag that “wraps around” other tags and does not have associated data. Meaning, its corresponding data size is zero (see FIG. 7 and corresponding text for further details regarding binary data container tags).

Processing analyzes the retrieved binary data size, and a determination is made as to whether the retrieved binary data header tag is a binary data container tag (decision 330). If the retrieved tag is a binary data container tag, decision 330 branches to “Yes” branch 332 whereupon processing opens a new container tag and stores the container tag in table 156 (step 335). Table 156 is the same as that shown in FIG. 1. Processing associates this tag to an open container, and includes subsequent binary data header tags in the open container until the container is closed (see below).

On the other hand, if the retrieved binary data header tag does not correspond to a binary data container tag, decision 330 branches to “No” branch 338 whereupon processing adds the binary data header tag and its corresponding binary data size to the table located in table store 155 (step 340).

A determination is made as to whether processing is at the end of a binary data container (decision 350). If processing is not at the end of a binary data container, decision 350 branches to “No” branch 352 whereupon processing retrieves (step 355) and processes the next header tag. This looping continues until processing reaches the end of a container, at which point decision 350 branches to “Yes” branch 358 whereupon processing closes the most recently opened container in table store 155 (step 360).

A determination is made as to whether processing has reached the end of the binary data header (decision 370). If processing has not reached the end of the binary data header, decision 370 branches to “No” branch 372 whereupon processing retrieves (step 355) and processes the next binary data header tag. This looping continues until processing reaches the end of the binary data header, at which point decision 370 branches to “Yes” branch 378.

Processing coverts the binary data header tags to markup language elements and converts the binary data sizes to markup language data sizes. In turn, processing writes the markup language elements and the markup language data sizes to a markup language header in markup language file store 160 (step 380). For example, if the markup language type is XML, processing generates a document type definition (DTD) and stores the DTD in markup language store 160 (see FIG. 9 and corresponding text for further details regarding markup language header properties). Markup language file store is the same as that shown in FIG. 1. Processing returns at 390.

FIG. 4 is a flowchart showing steps taken in converting binary data records to markup language records. Processing used a binary data header to generate a markup language header and, in doing so, stored binary data header tags and corresponding binary data sizes in table 156 (see FIG. 3 and corresponding text for further details regarding table information storing steps). Table 156 is the same as that shown in FIG. 1.

Processing commences at 400, whereupon processing retrieves a binary data record from binary data file store 140 (step 410). A binary data record includes a plurality of binary data values, some of which correspond to strings (see FIGS. 8A, 8B, and corresponding text for further details regarding binary data values).

At step 420, processing retrieves the first binary data header tag and size that was stored in table 156. A binary data size identifies the number of bytes in the binary data record that are dedicated to a header tag's corresponding binary data value. For example, if the first binary data size is “2” and corresponds to a header tag “name,” then the first two bytes that are included in a binary data record are the binary data value of the header tag “name.”

In the example described herein, the binary data size is segmented into three ranges, which are zero, greater than zero, and less than zero. If the binary data size is zero, then a binary data header tag that corresponds to the first binary data size is a binary data container tag. Meaning, the binary data header tag does not have associated data but, rather, it “contains” other binary data header tags that do have associated data. If the binary data size is greater than zero, then the corresponding binary data header tag has associated data whose binary data value byte size equals the binary data size, such as “4” bytes. If the binary data size is less than zero, then the associated binary data tag's value is a string value (see FIGS. 7, 8A, 8B, and corresponding text for further details regarding binary data sizes).

A determination is made as to the value of the retrieved binary data size (decision 430). If the binary data size is zero, decision 430 branches to “0” branch 432 whereupon processing writes a markup language tag that is a begin tag or an end tag, depending upon whether the binary data size corresponds to the beginning of a container or the end of a container, to a markup language record located in markup language file store 160 (step 435). The begin/end tag corresponds to the binary data header that was retrieved from table 156.

If the binary size value is greater than zero, decision 430 branches to “>0” branch 436 whereupon processing retrieves a value from the retrieved record that corresponds to the binary data size at step 440. For example, if the binary data size is four bytes, then processing retrieves four bytes from binary data file store 140. At step 445, processing writes a markup language begin tag, the retrieved value, and a markup language end tag to a markup language record that is located in markup language file store 160.

If the binary data size is less than zero, the corresponding binary data value is a string, and decision 430 branches to “<0” branch 438. Processing retrieves a number of bytes from the binary data record that equals the absolute value of the binary data size. For example, if the binary data size is “−2,” processing retrieves two bytes from binary data file store 140. At step 455, processing retrieves a string that corresponds to the retrieved value. For example if the retrieved value is “3,” processing retrieves the third string that is located in a string file. At step 460, processing writes a markup language begin tag, the string value, and a markup language end tag to markup language file store 160.

A determination is made as to whether there are more binary data header tags and sizes to process in table 156 (decision 470). If there are more binary data header tags and sizes to process, decision 470 branches to “Yes” branch 472 whereupon processing loops back to retrieve and process the next binary data header tag and size. This looping continues until there are no more binary data header tags and sizes to process, at which point decision 470 branches to “No” branch 478.

A determination is made as to whether there are more binary data records in the binary data file (decision 480). If there are more binary data records in the binary data file, decision 480 branches to “Yes” branch 482 which loops back to retrieve and process the next record. This looping continues until there are no more binary data records to process in the binary data file, at which point decision 480 branches to “No” branch 488 whereupon processing writes a markup language end tag to markup language file store 160 that signifies the end of the markup language records (step 490). Processing ends at 495.

FIG. 5 is a flowchart showing steps taken in converting a markup language header to a binary data header. Processing received a request to convert a markup language file to a binary data file. As such, processing converts a markup language header that is included in the markup language file to a binary data header. The markup language file is located in markup language file store 160, which is the same as that shown in FIG. 1.

Processing commences at 500, whereupon processing retrieves a markup language element from the markup language header that is located in markup language file store 160 (step 520). The markup language element may be a container element or a stand-alone element. A container element is an element that “contains” other elements and does not have associated data. A stand-alone element has associated data and may be encompassed by a container element (see FIG. 9 and corresponding text for further details regarding markup language element types).

A determination is made as to whether the retrieved element is a container element (decision 530). If the retrieved element is a container element, decision 530 branches to “Yes” branch 532 whereupon processing saves the number of stand-alone elements that are included the container element in table 158 (step 535). Table 158 is the same as that shown in FIG. 1. At step 540, processing converts the markup language element to a binary data header tag and writes the binary data header tag to a binary data header that is located in binary data file store 140. At step 545, since the element is a container element and does not have associated data, processing writes “0” to the binary data header as a corresponding binary data size. Binary data file store 140 is the same as that shown in FIG. 1.

On the other hand, if the retrieved element is not a container element, decision 530 branches to “No” branch 538 whereupon processing retrieves, in the case of XML, a corresponding ATTLIST from markup language file store 160. The ATTLIST includes the markup language data size that corresponds to the element. At step 555, processing saves the markup language element, size, and current offset in table 158. At step 556, processing adds the size to the offset.

Processing then converts the markup language element to a binary data header tag and converts the markup language data size to a binary data size, and writes the binary data header tag and the binary data size to the binary data header that is located in binary data file store 140 (step 560).

A determination is made as to whether processing has reached the end of a container element (decision 570). If processing has not reached the end of a container element, decision 570 branches to “No” branch 572, which loops back to retrieve and process the next element. This looping continues until processing reaches the end of a container element, at which point decision 570 branches to “Yes” branch 578.

At step 580, processing stores a null string as a binary data header tag and zero as a corresponding binary data size in the binary data header that is located in binary data file 140, thus signifying the end of a container element.

A determination is made as to whether processing has reached the end of the markup language header (decision 590). If processing has not reached the end of the markup language header, decision 590 branches to “No” branch 592, which loops back to retrieve and process the next element. This looping continues until processing reaches the end of the markup language header, at which point decision 590 branches to “Yes” branch 598 whereupon processing returns at 599.

FIG. 6 is a flowchart showing steps taken in converting markup language records to binary data records. Processing used a markup language header to generate a binary data header and, in doing so, stored binary data header tags and corresponding binary data sizes in table 158 (see FIG. 5 and corresponding text for further details regarding table information storing steps). Table 158 is the same as that shown in FIG. 1.

Processing commences at 600, whereupon processing resets a string counter at step 610. The string counter is used to track which string to retrieve from a string file when a binary data value corresponds to a string. At step 620, processing selects a first markup language record and its corresponding markup language data value that is located in markup language file store 160. Processing identifies a first markup language tag that is included in the markup language record at step 630.

At step 640, processing retrieves a corresponding markup language data size and offset that are stored in table 158. The markup language data size corresponds to the number of bytes of the markup language tag's value, such as two bytes. The offset corresponds to the location in a binary data record to store a corresponding binary data value (see FIG. 5 and corresponding text for further details regarding offset locations).

A determination is made as to whether the markup language tag's corresponding value is a string based upon the markup language data size (decision 650). For example, if the markup language data size is less than zero, processing identifies that the corresponding markup language data value is a string. If the markup language data value is a string, decision 650 branches to “Yes” branch 652 whereupon processing writes the markup language data value to a string file located in temporary store 657 at the string counter location. Temporary store 657 may be stored on a nonvolatile storage area, such as a computer hard drive.

At step 656, processing stores the string counter value as a binary data value at the corresponding offset in temporary store 657 and, at step 660, processing increments the string counter. In one embodiment, processing may re-use string counter values whose strings exists at multiple record locations. For example, if the string “printer Y” exists at multiple record locations and has a corresponding string index of “2,” processing stores a string index of “2” in temporary store 657 for each occurrence of “printer Y.”

On the other hand, if the markup language data value is not a string, decision 650 branches to “No” branch 658 whereupon processing stores the markup language data value as a binary data value at the corresponding offset in temporary store 657 (step 665).

A determination is made as to whether processing has reached the end of the markup language record (decision 670). If processing has not reached the end of the markup language record, decision 670 branches to “No” branch 672 whereupon processing retrieves (step 675) and processes the next tag in the record. This looping continues until processing reaches the end of the record, at which point decision 670 branches to “Yes” branch 678, whereupon processing uses the information in temporary store 657 to generate a binary data record and write the binary data record to the binary file that is located in data file store 140 (step 680).

A determination is made as to whether processing has reached the end of the markup language file (decision 690). If processing has not reached the end if the markup language file, decision 690 branches to “No” branch 692 which loops back to select (step 695) and process the next markup language record. This looping continues until processing reaches the end of the markup language file, at which point decision 690 branches to “Yes” branch 698 whereupon processing returns at 699.

FIG. 7 is an example of a binary data header that is generated from a markup language header. Binary data header 145 is the same as that shown in FIG. 1, and includes binary data header tags and binary data sizes. The binary data header tags correspond to markup language elements that are included in a markup language header, such as markup language header 165 shown in FIGS. 1 and 9. In addition, the binary data sizes correspond to markup language data sizes that are included in the markup language header.

Some binary data header tags are binary data “container” tags, such as tag 700 shown in FIG. 7. A binary data container tag is a tag that “wraps around” or encompasses other binary data header tags, and does not have associated data. As can be seen, tag 700's associated binary data size is data size 702, which is “0.” Tag 704 is also a binary data container tag whose associated binary data size is data size 706, which is “0.”

Tag 708 is a stand-alone binary data header tag in that it has associated data, which is data size 710 that has a value of “−2.” The negative value indicates that the corresponding data value is actually a string value whose string location is represented by two bytes in a binary data record. Tag 712 is also a stand-alone binary data header whose data size is data size 714. Data size 714 is “2,” which indicates that the corresponding data value is represented by two bytes in a binary data record.

Binary data header 145 also includes stand-alone tags 716, 720, 730, 734, 738, 748, and 752 that have corresponding data sizes 718, 722, 732, 736, 740, 750, and 754, respectively. In addition, binary data header 145 includes container tags 724 and 744, which have corresponding data sizes 726 and 746, respectively, that have a value of “0.”

Binary data header 145 includes tags 742, 756, 758, and 760. These tags have a null string as their tag name, representing the end of a container tag. As can be seen, these tags do not have corresponding data sizes. A file converter uses binary data header 145 in conjunction with binary data records and a string file to generate a markup language file (see FIGS. 8A, 8B, and corresponding text for further details regarding binary data records and string files, respectively).

FIG. 8A is an example of binary data records. Binary data records are generated from markup language records once a corresponding binary data header has been generated from a markup language header. Binary data records 150 are the same as that shown in FIG. 1, and include records 800 and 840, which correspond to markup language records 1000 and 1040, respectively, that are shown in FIG. 10.

Record 800 includes binary data values 820 through 836, which are stored at offsets 802 through 818, respectively. Binary data values 820, 828, 832, and 834 correspond to strings and include the string location of their respective strings. Meaning, the data records value for these particular entries are stored in a string file, such as string file 152 shown in FIG. 8B. Binary data value 820 has a value of “0,” which signifies that its string is located in a string file at location “0.” Using string file 152 shown in FIG. 8B as an example, string 852 “Fred” is binary data value 820's corresponding string. Continuing with this example, string 854, 856 and 858 are binary data values 828, 832, and 834's corresponding strings (see FIG. 8B and corresponding text for further details regarding strings).

FIG. 8B is an example of a binary data string file. A file converter generates string file 152 when, during a markup language conversion process, the file converter identifies a markup language data size that corresponds to a string (see FIG. 6 and corresponding text for further details regarding markup language data sizes). String file 152 is the same as that shown in FIG. 1.

String file 152 includes strings 852 through 866. As discussed above, strings 852 through 858 correspond to record 800. Likewise, strings 860 through 866 correspond to record 840. During a markup language file conversion process, a file converter adds string values to string file 152 at particular string counter locations until the file converter reaches the end of markup language records that are included in the markup language file.

FIG. 9 is an example of a markup language header that is generated from a binary data header. Markup language header 165 is the same as that shown in FIG. 1, and includes markup language elements and markup language data sizes. The markup language elements correspond to binary data header tags that are included in a binary data header, such as binary data header 145 shown in FIG. 7. In addition, the markup language data sizes correspond to binary data sizes that are included in the binary data header.

Some markup language elements are “container” elements, such as element 910 shown in FIG. 9. A container element is an element that encompasses other markup language elements, and does not have an associated data size. As can be seen, element 910 does not have an associated data size, but rather encompasses elements that are included in box 920.

Element 930 has an associated data size, which is markup language data size 940. Markup language data size 940's value is “−2.” The negative value indicates that element 930's corresponding data value is actually a string value in a markup language record which, when stored in a string file, its string location value requires two bytes.

Markup language header 165 also includes element 950, which has an associated data size, which is markup language data size 960. Markup language data size 960's value is “2,” which signifies that element 950's corresponding data value in a markup language record is two bytes in length (see FIG. 10 and corresponding text for further details regarding markup language records).

FIG. 10 is an example of markup language records. Markup language records are generated from binary data records once a corresponding markup language header has been generated from a binary data header. Markup language records 170 are the same as that shown in FIG. 1, and include records 1000 and 1040, which correspond to binary data records 800 and 840, respectively, that are shown in FIG. 8A.

Record 1000 includes markup language tags 1010, 1020, and 1040. Markup language tag 1010 is a markup language container tag and does not have an associated tag value. Markup language tag 1020 is a begin tag and markup language tag 1040 is its corresponding end tag. Between the two tags lies the tag's corresponding markup language data value, which is markup language data value 1030. As can be seen looking at markup language data size 940 shown in FIG. 9, markup language data value 1030 is a string value.

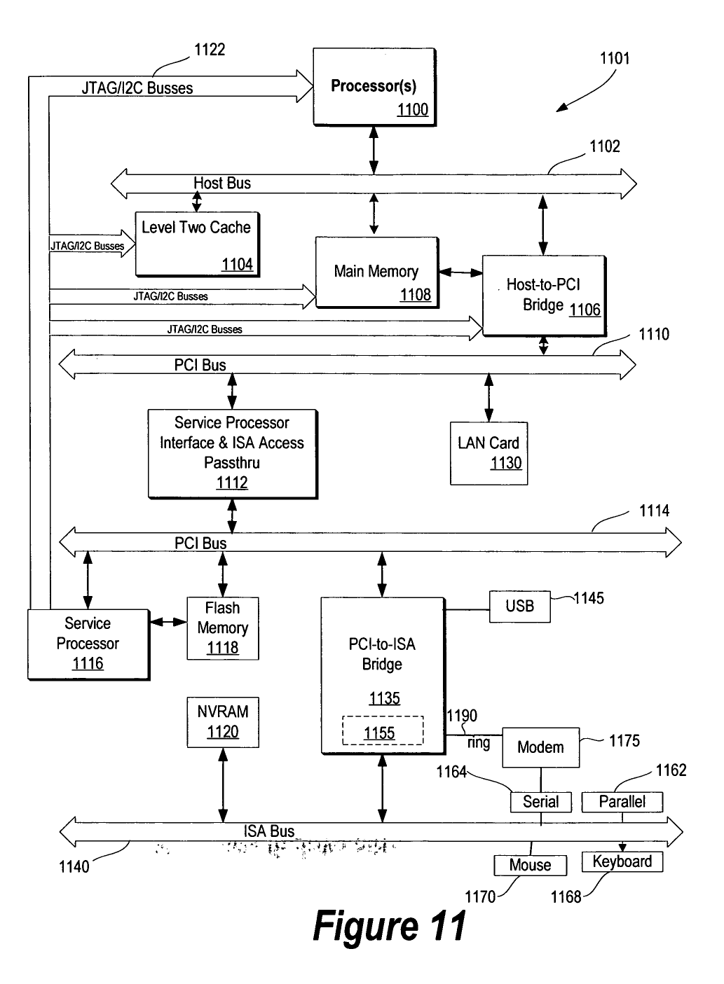

FIG. 11 illustrates information handling system 1101 which is a simplified example of a computer system capable of performing the computing operations described herein. Computer system 1101 includes processor 1100 which is coupled to host bus 1102. A level two (L2) cache memory 1104 is also coupled to host bus 1102. Host-to-PCI bridge 1106 is coupled to main memory 1108, includes cache memory and main memory control functions, and provides bus control to handle transfers among PCI bus 1110, processor 1100, L2 cache 1104, main memory 1108, and host bus 1102. Main memory 1108 is coupled to Host-to-PCI bridge 1106 as well as host bus 1102. Devices used solely by host processor(s) 1100, such as LAN card 1130, are coupled to PCI bus 1110. Service Processor Interface and ISA Access Pass-through 1112 provides an interface between PCI bus 1110 and PCI bus 1114. In this manner, PCI bus 1114 is insulated from PCI bus 1110. Devices, such as flash memory 1118, are coupled to PCI bus 1114. In one implementation, flash memory 1118 includes BIOS code that incorporates the necessary processor executable code for a variety of low-level system functions and system boot functions.

PCI bus 1114 provides an interface for a variety of devices that are shared by host processor(s) 1100 and Service Processor 1116 including, for example, flash memory 1118. PCI-to-ISA bridge 1135 provides bus control to handle transfers between PCI bus 1114 and ISA bus 1140, universal serial bus (USB) functionality 1145, power management functionality 1155, and can include other functional elements not shown, such as a real-time clock (RTC), DMA control, interrupt support, and system management bus support. Nonvolatile RAM 1120 is attached to ISA Bus 1140. Service Processor 1116 includes JTAG and I2C busses 1122 for communication with processor(s) 1100 during initialization steps. JTAG/I2C busses 1122 are also coupled to L2 cache 1104, Host-to-PCI bridge 1106, and main memory 1108 providing a communications path between the processor, the Service Processor, the L2 cache, the Host-to-PCI bridge, and the main memory. Service Processor 1116 also has access to system power resources for powering down information handling device 1101.

Peripheral devices and input/output (I/O) devices can be attached to various interfaces (e.g., parallel interface 1162, serial interface 1164, keyboard interface 1168, and mouse interface 1170 coupled to ISA bus 1140. Alternatively, many I/O devices can be accommodated by a super I/O controller (not shown) attached to ISA bus 1140.

In order to attach computer system 1101 to another computer system to copy files over a network, LAN card 1130 is coupled to PCI bus 1110. Similarly, to connect computer system 1101 to an ISP to connect to the Internet using a telephone line connection, modem 1175 is connected to serial port 1164 and PCI-to-ISA Bridge 1135.

While the computer system described in FIG. 11 is capable of executing the processes described herein, this computer system is simply one example of a computer system. Those skilled in the art will appreciate that many other computer system designs are capable of performing the processes described herein.

One of the preferred implementations of the invention is a client application, namely, a set of instructions (program code) in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer-implemented method comprising:
retrieving a binary data file;
translating the binary data file to a markup language file;
modifying the markup language file, resulting in a modified markup language file; and
converting the modified markup language file to a modified binary data file.

2. The method of claim 1 further comprising:
wherein the binary data file includes a binary data header and one or more binary data records; and
wherein the markup language file includes a markup language header and one or more markup language records, the markup language header corresponding to the binary data header and the one or more markup language records corresponding to the one or more binary data records.

3. The method of claim 2 wherein the translating further comprises:
identifying, in the binary data header, a plurality of binary data header tags and a corresponding plurality of binary data sizes;
generating a plurality of markup language elements and a corresponding plurality of markup language data sizes based upon the plurality of binary data header tags and the plurality of binary data sizes;
storing the plurality of markup language elements and the plurality of markup language data sizes in the markup language header;
selecting one of the binary data header tags and the corresponding binary data size;
retrieving a binary data value from one of the binary data records corresponding to binary data size; and
generating one of the markup language records using the binary data value and binary data header tag.

4. The method of claim 3 further comprising:
determining whether the markup language data size corresponds to a string; and
retrieving the corresponding string based upon the binary data value.

5. The method of claim 2 wherein the converting further comprises:
identifying, in the markup language header, a plurality of markup language elements and a corresponding plurality of markup language data sizes;
generating a plurality of binary data header tags and a corresponding plurality of binary data sizes based upon the plurality of markup language elements and the plurality of markup language data sizes;
storing the plurality of binary data header tags and the plurality of binary data sizes in the binary data header;
selecting a markup language tag and a corresponding markup language data value that is included in one of the plurality of markup language records; and
generating one of the binary data records using the markup language data value.

6. The method of claim 5 further comprising:
determining whether the markup language data size corresponds to a string; and
retrieving the corresponding string based upon the determination.

7. The method of claim 1 wherein the markup language file is generated using Extensible Markup Language.

8. A computer program product comprising:
a computer operable medium having computer readable code, the computer readable code being effective to:
retrieve a binary data file;
translate the binary data file to a markup language file;
modify the markup language file, resulting in a modified markup language file; and
convert the modified markup language file to a modified binary data file.

9. The computer program product of claim 8 wherein the binary data file includes a binary data header and one or more binary data records and wherein the markup language file includes a markup language header and one or more markup language records, the markup language header corresponding to the binary data header and the one or more markup language records corresponding to the one or more binary data records.

10. The computer program product of claim 9 wherein the computer readable code is further effective to:
identify, in the binary data header, a plurality of binary data header tags and a corresponding plurality of binary data sizes;
generate a plurality of markup language elements and a corresponding plurality of markup language data sizes based upon the plurality of binary data header tags and the plurality of binary data sizes;
store the plurality of markup language elements and the plurality of markup language data sizes in the markup language header;
select one of the binary data header tags and the corresponding binary data size;
retrieve a binary data value from one of the binary data records corresponding to binary data size; and
generate one of the markup language records using the binary data value and binary data header tag.

11. The computer program product of claim 10 wherein the computer readable code is further effective to:
determine whether the markup language data size corresponds to a string; and
retrieve the corresponding string based upon the binary data value.

12. The computer program product of claim 9 wherein the computer readable code is further effective to:
identify, in the markup language header, a plurality of markup language elements and a corresponding plurality of markup language data sizes;
generate a plurality of binary data header tags and a corresponding plurality of binary data sizes based upon the plurality of markup language elements and the plurality of markup language data sizes;
store the plurality of binary data header tags and the plurality of binary data sizes in the binary data header;
select a markup language tag and a corresponding markup language data value that is included in one of the plurality of markup language records; and
generate one of the binary data records using the markup language data value.

13. The computer program product of claim 12 wherein the computer readable code is further effective to:
determine whether the markup language data size corresponds to a string; and
retrieve the corresponding string based upon the determination.

14. The computer program product of claim 8 wherein the markup language file is generated using Extensible Markup Language.

15. An information handling system comprising:
one or more processors;
a memory accessible by the processors;
one or more nonvolatile storage devices accessible by the processors; and
a file translation tool for translating between a binary data file and a markup language file, the file translation tool being effective to:
retrieve the binary data file from one of the nonvolatile storage devices;
translate the binary data file to the markup language file and store the markup language file in one of the nonvolatile storage devices;
modify the markup language file, resulting in a modified markup language file; and
convert the modified markup language file to a modified binary data file.

16. The information handling system of claim 15 wherein the binary data file includes a binary data header and one or more binary data records and wherein the markup language file includes a markup language header and one or more markup language records, the markup language header corresponding to the binary data header and the one or more markup language records corresponding to the one or more binary data records.

17. The information handling system of claim 16 wherein the file translation tool is further effective to:
identify, in the binary data header, a plurality of binary data header tags and a corresponding plurality of binary data sizes;
generate a plurality of markup language elements and a corresponding plurality of markup language data sizes based upon the plurality of binary data header tags and the plurality of binary data sizes;
store the plurality of markup language elements and the plurality of markup language data sizes in the markup language header that is located on one of the nonvolatile storage devices;
select one of the binary data header tags and the corresponding binary data size;
retrieve, from one of the nonvolatile storage devices, a binary data value from one of the binary data records corresponding to binary data size; and
generate one of the markup language records using the binary data value and binary data header tag.

18. The information handling system of claim 17 wherein the file translation tool is further effective to:
determine whether the markup language data size corresponds to a string; and
retrieve, from one of the nonvolatile storage devices, the corresponding string based upon the binary data value.

19. The information handling system of claim 16 wherein the file translation tool is further effective to:
identify, in the markup language header, a plurality of markup language elements and a corresponding plurality of markup language data sizes;
generate a plurality of binary data header tags and a corresponding plurality of binary data sizes based upon the plurality of markup language elements and the plurality of markup language data sizes;
store, in one of the nonvolatile storage devices, the plurality of binary data header tags and the plurality of binary data sizes in the binary data header;
select a markup language tag and a corresponding markup language data value that is included in one of the plurality of markup language records and located on one of the nonvolatile storage devices; and
generate one of the binary data records using the markup language data value.

20. The information handling system of claim 19 wherein the file translation tool is further effective to:
determine whether the markup language data size corresponds to a string; and
retrieve the corresponding string from one of the nonvolatile storage devices based upon the determination.
